(19) United States
(12) Patent Application Publication
(10) Pub. No.: US 2010/0061017 A1
(43) Pub. Date: Mar. 11, 2010

(54) RECORDING TAPE CARTRIDGE

(75) Inventor: Kazuo HIRAGUCHI, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/553,121

(22) Filed: Sep. 3, 2009

(30) Foreign Application Priority Data
Sep. 11, 2008 (JP) 2008-233369

(51) Int. Cl. G11B 5/78

(52) U.S. Cl. 360/134; G9B/5.291

(57) ABSTRACT

A recording tape cartridge comprising a casing that rotatably accommodates a single reel on which recording tape is wound; a shielding component that slides substantially along a side wall of the casing to open or block off an opening that is formed in the side wall for pulling out the recording tape; and a biasing projection provided projecting out from the casing and biasing the shielding component toward the side wall side when the shielding component has blocked off the opening.

### CROSS-REFERENCE TO RELATED APPLICATION

This application claims priority under 35 USC 119 from Japanese Patent Application No. 2008-233369 filed on Sep. 11, 2008, the disclosure of which is incorporated by reference herein.

### BACKGROUND OF THE INVENTION

1. Technical Field

The present invention relates to a recording tape cartridge that accommodates in a case a single reel on which is wound recording tape, such as magnetic tape that is mainly used as a computer recording and reproduction medium for computers etc.

2. Related Art

There have previously been reels on which is wound recording tape, such as magnetic tape used as a computer recording and reproduction medium for computers etc., and cartridges are known that accommodate within a case such a single reel. A leader component that includes a leader pin, leader tape and leader block, is provided to the leading end of the recording tape. A withdrawing means provided at the drive device side pulls the leader component out from an opening in the recording tape cartridge, such that the recording tape fixed to the leader component is wound on a take-up reel on the drive device side.

In recording tape cartridges of such a configuration, the position of the opening and the type of door (shielding component) for closing off the opening is different for each type of leader component. For example, when the leader component is a leader pin, as described in Japanese Patent Application Laid-Open (JP-A) No. 2004-30760, the opening is formed in the side wall of the corner portion at the side of loading into the drive device, such that the opening is closed off by a door that slides in a direction parallel to the direction of loading into drive device, or a substantially circular arc shaped door, in plan view, that slides along a specific circular circumference.

### SUMMARY

However, when configuration is made such that the opening is closed off by a shielding component that slides, a certain gap can arise between the shielding component and the side walls forming the opening in order for the shielding component to slide smoothly. The gap is also made due to a draft angle when molding or deformation such as warping etc. Consequently there is a concern that dust etc. enters through such a gap at times such as when the recording tape cartridge is not used, that is the cartridge is not loaded in the drive device, and during storage or transport).

The present invention is made in consideration of the above circumstances and provides a recording tape cartridge that can suppress intrusion of dust etc. through the gap that might have arisen between a shielding component that slides and side walls forming an opening, and that can improve the dustproof properties of the recording tape cartridge.

A recording tape cartridge of a first aspect of the present invention is a recording tape cartridge including: a casing that rotatably accommodates a single reel on which recording tape is wound; a shielding component that slides substantially along a side wall of the casing to open or block off an opening that is formed in the side wall for pulling out the recording tape; and a biasing projection provided projecting out from the casing and biasing the shielding component toward the side wall side when the shielding component has blocked off the opening.

According to the recording tape cartridge of the first aspect, when the shielding component slides substantially along the side wall and has blocked off the opening, the shielding component is biased toward the side wall by the biasing projection. Any gap that might have arisen between the shielding component and the side wall in which the opening is formed can be substantially blocked by the shielding component itself. Consequently intrusion of dust etc. through such a gap can be suppressed, and the dustproof properties of the recording tape cartridge can be improved.

A recording tape cartridge of a second aspect of the present invention is the recording tape cartridge of the first aspect wherein the biasing projection projects out in the vicinity of an edge portion of the side wall where the opening is formed.

According to the recording tape cartridge of the second aspect, since the biasing projection projects out in the vicinity of an edge portion of the side wall where the opening is formed, when the shielding component blocks off the opening, the shielding component is pressed against the edge portion of the side wall by the biasing projection. Consequently any gap that might have arisen between the shielding component and the edge portion of the side wall where the opening is formed can be substantially blocked by the shielding component itself, and intrusion of dust etc. through such a gap can be suppressed, or moreover prevented.

A recording tape cartridge of a third aspect of the present invention is the recording tape cartridge of the first aspect or the second aspect, wherein the maximum plate thickness of a portion of the shielding component interposed between the side wall and the biasing projection when the opening is blocked off is the same thickness as, or a greater thickness than, the separation between the side wall and the biasing projection.

According to the recording tape cartridge of the third aspect, since the maximum plate thickness of the portion of the shielding component interposed between the side wall and the biasing projection when the opening is blocked off is the same thickness as, or a greater thickness than, the separation between the side wall and the biasing projection, any gap that might have arisen between the shielding component and the side wall formed with the opening (the edge portion of the side wall where the opening is formed) can be substantially blocked off by the shielding component. Consequently intrusion of dust etc. through such a gap can be suppressed, or moreover prevented.

A recording tape cartridge of a fourth aspect of the present invention is a recording tape cartridge of any one of the above aspects wherein in order to pull out the recording tape a leader component is attached to an end portion of the recording tape.

In a recording tape cartridge of a fifth aspect of the present invention the biasing projection is provided for biasing at positions in the vicinity of each of the two ends in the sliding direction of the shielding component for blocking the opening.

According to the recording tape cartridge of the fifth aspect, since the biasing projection is provided for biasing at positions in the vicinity of each of the two ends in the sliding direction of the shielding component for blocking the opening, when the shielding component blocks off the opening, the shielding component is pressed against the side wall by the biasing projections. Consequently any gaps that might have arisen between the sliding shielding component and the side wall where the opening is formed can be substantially blocked by the shielding component itself, and intrusion of dust etc. through such an opening can be suppressed, or moreover prevented.

As described above, according to the recording tape cartridges of each of the above aspects, a recording tape cartridge is provided that can suppress intrusion of dust etc. through any gap that might have arisen between the sliding shielding component and the side wall where the opening is formed, and can improve the dustproof properties of the recording tape cartridge.

### BRIEF DESCRIPTION OF THE DRAWINGS

Exemplary embodiments of the present invention will be described in detail based on the following figures, wherein:

FIG. 1 is a schematic perspective view of a recording tape cartridge;

FIG. 2 is a schematic exploded perspective view of a recording tape cartridge, as viewed from above;

FIG. 3 is a schematic exploded perspective view of a recording tape cartridge, as viewed from below;

FIG. 4A is a schematic perspective view showing a state in which a shielding component closes off an opening; FIG. 4B is a schematic perspective view showing a state in which a shielding component opens an opening; and

FIG. 5 is a schematic plan view showing a state in which a shielding component closes off an opening.

### DETAILED DESCRIPTION OF THE INVENTION

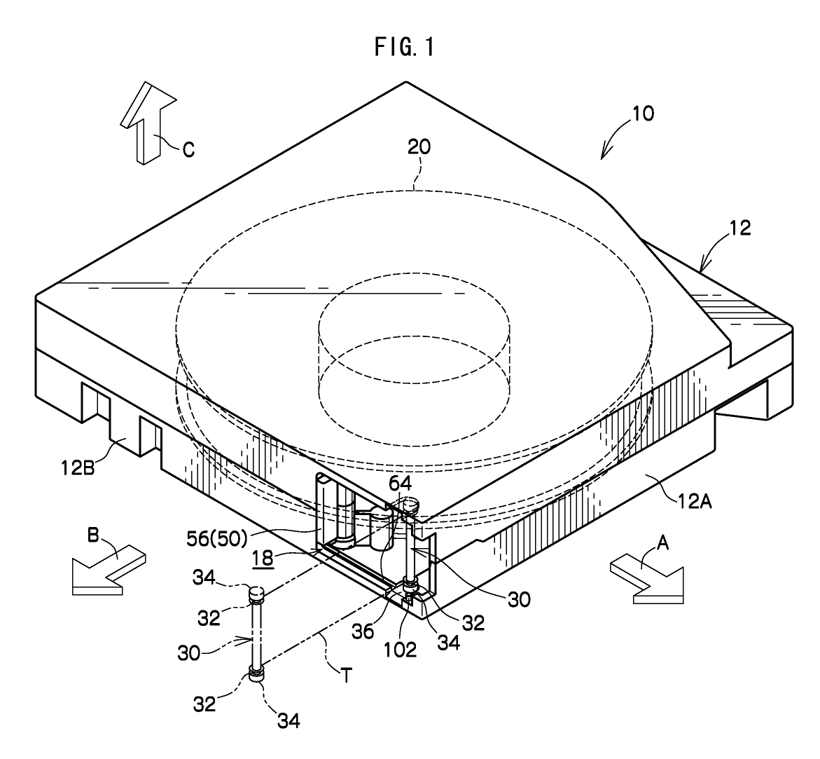

Herebelow, an example of an exemplary embodiment of the present invention will be described in detail with reference to the drawings. For ease of explanation, the direction of loading a recording tape cartridge 10 into a drive device is shown in FIG. 1 by the arrow A, and this is designated as the front direction (front side) of the recording tape cartridge 10. The direction shown by the arrow B, orthogonal to the direction of arrow A, is designated as the right direction (right side). The direction shown by arrow C, orthogonal to both the direction of arrow A and the direction of arrow B, is designated at the up direction (top side) of the recording tape cartridge 10.

As shown in FIG. 1 to FIG. 3, the recording tape cartridge 10 is configured with a substantially rectangular shaped casing 12. The casing 12 is configured with an upper casing 14 and a lower casing 16, these being made from a resin such as polycarbonate (PC) or the like, with the upper casing 14 and the lower casing 16 respectively joined together by ultrasonic welding or screw fasteners etc. in a state in which a peripheral wall 14B provided extending down from the peripheral edge of a top panel 14A and a peripheral wall 16B provided extending up from the peripheral edge of a bottom panel 16A are in contact with each other.

Namely, for example, screw bosses 15 are formed to portions in the vicinity of each of the corner portions of the upper casing 14 and the lower casing 16 respectively, such that the casing 12 is assembled by screwing (not shown) into the screw bosses 15 from the bottom face of the lower casing 16. A reel 20 is rotatably accommodated inside the casing 12.

This reel 20 is configured with a circular cylindrical reel hub 22 having a bottom that forms the central axis portion, with an integrally formed lower flange 26 provided at the bottom portion of the reel hub 22, and with an upper flange 24 ultrasonically welded to the top end portion of the reel hub 22. A recording tape T such as magnetic tape is wound around the outer peripheral surface of the reel hub 22 and acts as information recording/playback medium. The end portions in the widthwise direction of the wound recording tape T are retained by the upper flange 24 and the lower flange 26.

A reel gear 44 is formed in a ring shape to the bottom face of a bottom wall 28 of the reel hub 22, and a gear opening 40 is also provided piercing through the central portion of the lower casing 16, in order to externally expose the reel gear 44. The reel 20 is rotated with respect to the casing 12 by meshing the reel gear 44, exposed through the gear opening 40, with a drive gear (not shown in the drawings) formed to a rotation shaft of the drive device (not shown in the drawings).

An annular metal reel plate 46 made from a magnetic material is fixed concentrically and integrally by a process such as insert molding at the radial direction inside of the reel gear 44 at the bottom surface of the bottom wall 28. The reel plate 46 is attracted and retained by the magnetic force of a ring shaped magnet (not shown) provided to a rotation shaft of the drive device. Furthermore, the reel 20 is retained by play-restricting walls 42 so as not to rattle around. The play-restricting walls 42 are provided so as to protrude from portions of the inner surfaces of each of the top casing 14 and the bottom casing 16, and act as an inner wall on a circular track that is coaxial with the gear opening 40.

An opening 18 is formed in a right side wall 12B of the casing 12 through which the recording tape T wound on the reel 20 is pulled out, and a leader pin 30 is fixed to the free end of the recording tape T, with the recording tape T pulled out from the opening 18 by latching (engaging) with a pull-out component (not shown in the drawings) of the drive device. Annular grooves 32 are formed at both end portions in the longitudinal direction of the leader pin 30 and project out from the both edges in the width direction of the recording tape T. The annular grooves 32 are latched by hooks or the like of the pull-out component. The hooks or the like thereby do not make contact with, or damage, the recording tape T when the recording tape T is being pulled out.

Further, a pair of upper and lower pin-retaining portions 36 that position and retain the leader pin 30 are provided at the inside of the opening 18 in the casing 12, that is, in the inner surfaces of the top panel 14A of the top casing 14 and the bottom panel 16A of the bottom casing 16. The pin-retaining portions 36 are formed into substantially semi-circle shapes open to the side from which the recording tape T is pulled out, and end portions 34 at both ends of the leader pin 30 are made so as to be insertable into and removable from the open sides of the pin-retaining portions 36 when the leader pin 30 is in an upright state.

A plate spring 38 is fixed in the vicinity of the pin retaining portions 36, the leading end portions of the two forks of the plate spring 38 engaging with the upper and lower end portions 34 of the leader pin 30 and retaining the leader pin 30 in the pin retaining portions 36. The leading ends of the plate spring 38 undergo appropriate elastic deformation when the leader pin 30 exits or enters the pin retaining portions 36, such that movement of the leader pin 30 is permitted.

The opening 18 is blocked off by a door 50. The door 50 is formed in a substantially rectangular plate shape of a size sufficiently large to block off the opening 18, the door 50 moving (sliding) substantially along the right side wall 12B of the casing 12 at the inside of the right side wall 12B. Grooved portions 64 are formed to the top panel 14A and the bottom panel 16A at the inside of the opening 18, such that the upper and lower edge portions of the door 50 fit slidably therein.

A shaft 52 is provided projecting out from a central portion at the rear end of the door 50, and a coil spring 58 fits over the shaft 52. A widened portion 54 is formed at the rear end of the shaft 52 to prevent the coil spring 58 from coming off. A support plate 60 is provided protruding out from the lower casing 16, the support plate 60 having a latching portion 62 for latching the rear end of the coil spring 58 fitted over the shaft 52.

Consequently, the door 50 is constantly biased in the closing direction by biasing force from the coil spring 58, with the shaft 52 slidably supported on the support plate 60 and the rear end of the coil spring 58 latched to the latching portion 62. It should be noted that it is preferable to further provide a support plate 66 protruding at the rear end side of the support plate 60 to support the shaft 52 when the opening 18 is open.

A protruding portion 56 is provided at a front end portion of the door 50, the protruding portion 56 protruding out toward the outside of the casing. The protruding portion 56 engages with an opening and closing member (not shown in the drawings) on the drive device side when the recording tape cartridge 10 is loaded into the drive device. The door 50 is thereby opened against the biasing force of the coil spring 58.

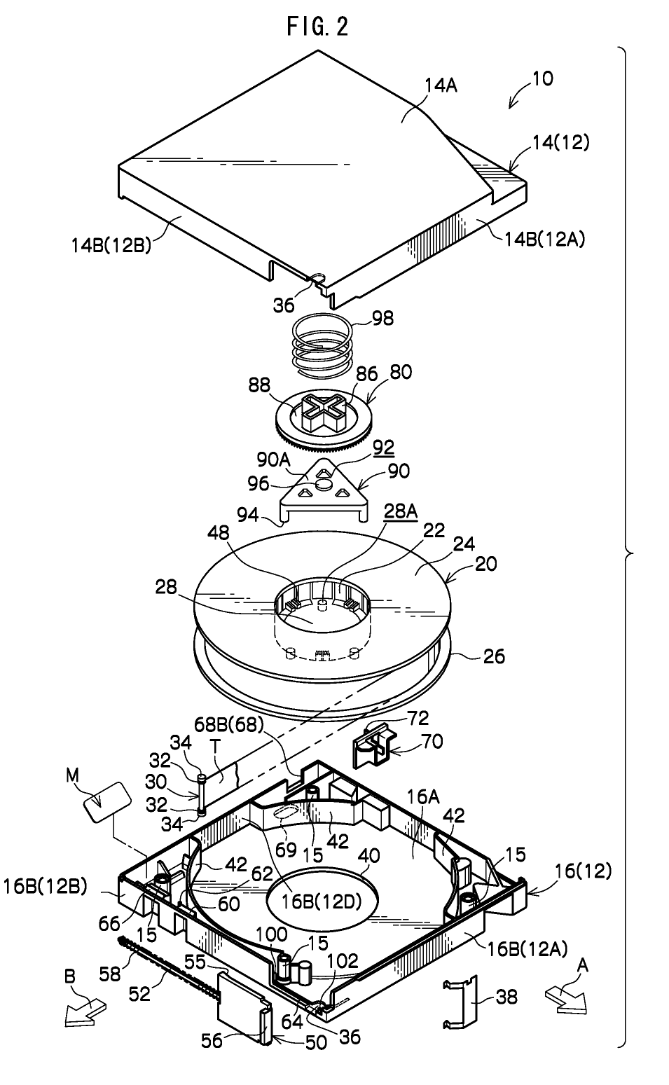

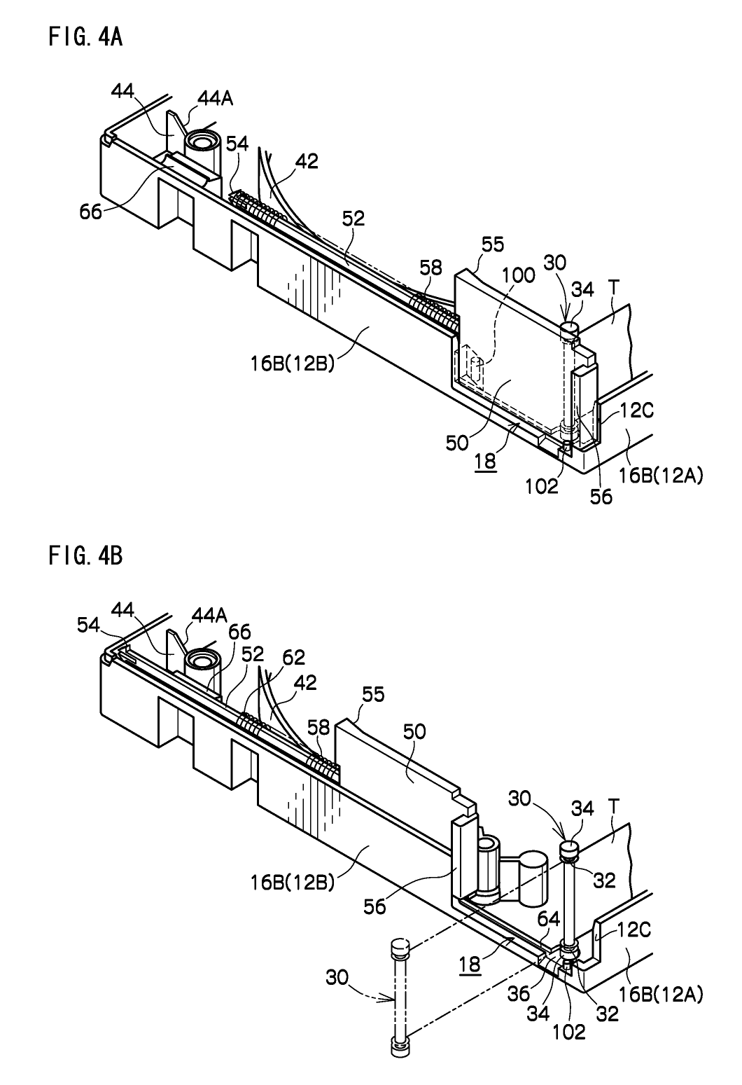

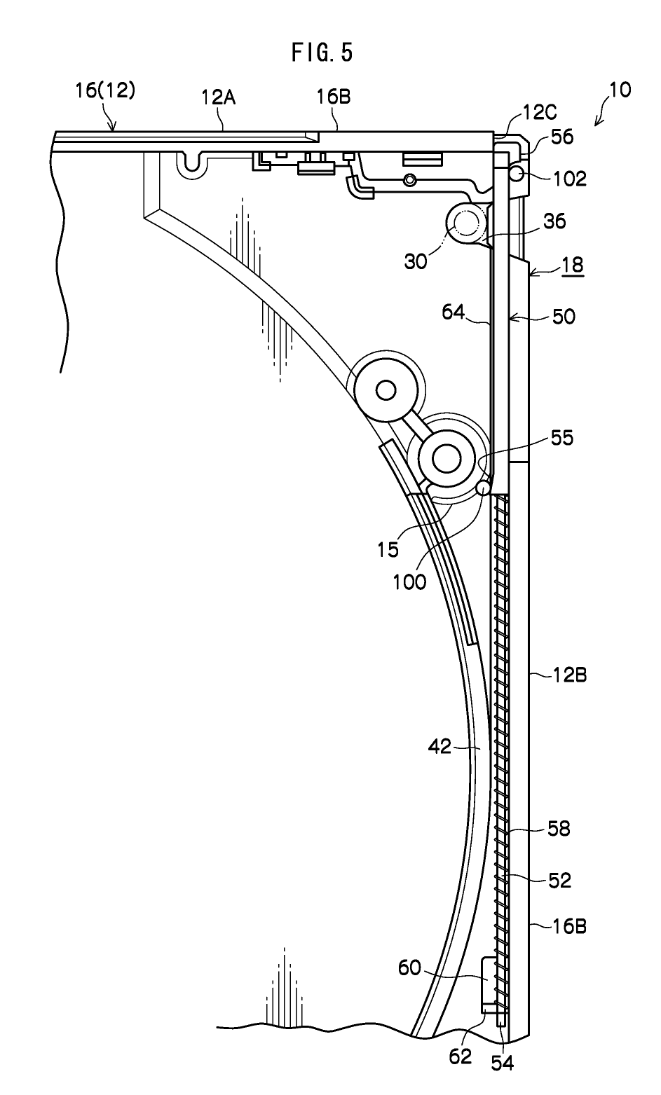

Biasing projections 100 of substantially circular pillar shape are provided between the right side wall 12B and the screw bosses 15 at the right-front side, for pressing a portion of the outer face of the rear end portion of the door 50 against the inside face of the right side wall 12B, that is biasing the rear end portion of the door 50 toward outside of the casing when the opening 18 is blocked off by the door 50, as shown in FIG. 2 to FIG. 5. The biasing projections 100 are integrally provided projecting out with a specific height that does not exceed the respective heights of the peripheral walls 14B, 16B) from the upper casing 14 and the lower casing 16, respectively, at specific positions on the inside face of the top panel 14A of the upper casing 14 and on the inside face of the bottom panel 16A of the lower casing 16. The positions locate in the vicinity of portions configuring the edge of the opening 18 of the right side wall 12B.

Namely, there is a tapered face 55 at the rear end portion of the door 50 such that the plate thickness thereat is thicker than at other positions of the door 50. The maximum plate thickness at the rear end portion of the door 50, when interposed between the biasing projections 100 and the inside face of the right side wall 12B when the opening is blocked off, has a thickness that is the same as, or greater than, the smallest separation distance (gap) between the biasing projections 100 and the inside face of the right side wall 12B. The rear end portion of the door 50 is consequently pressed toward the right side wall 12B side by the biasing projections 100 when interposed between the biasing projections 100 and the inside face of the right side wall 12B.

The outside face of the rear end portion of the door 50 is thereby made in press contact to abut the inside face of the right side wall 12B when the opening 18 is blocked off by the door 50, and a gap which might have arisen between the edge portion at the right side wall 12B where the opening 18 is formed and the door 50 is substantially blocked by the door 50. Namely, intrusion of dust etc. through such a gap when the recording tape cartridge 10 is not being used is suppressed, or moreover prevented.

The biasing projections 100 may be configured as separate parts from the casing 12, and attached so as to project out from the upper casing 14 and the lower casing 16 respectively. In such cases the biasing projections 100 are preferably formed from polyacetal (POM), which has superior sliding properties. The shape of the biasing projections 100 is not limited to the illustrated substantially circular pillar shape, and a shape may be adopted (not shown) having a tapered face capable of face-to-face contact so as to slide contact with the tapered face 55 of the inside face of the door 50.

In addition, substantially circular pillar shaped ancillary biasing projections 102 may be provided projecting out in a similar manner at specific heights that do not interfere with the protruding portion 56 at portions in the vicinity of the front wall 12A side of the right side wall 12B, so as to press the inside face of a front portion of the door 50 against the right end face 12C of the front wall 12A.

Namely, the ancillary biasing projections 102 project out slightly further to the inside of the casing than the grooved portions 64 that are formed to the inside face of the top panel 14A and the bottom panel 16A, so that the ancillary biasing projections 102 bias the front end portion of the door 50 toward the casing inside when the opening 18 is blocked off by the door 50, with the inside face of the front end portion of the door 50 in press contact to abut the right end face 12C of the front wall 12A. Any gap which might have arisen between the inside face of the front end portion of the door 50 and the right end face 12C of the front wall 12A is substantially blocked by the door 50, and intrusion of dust etc. through such a gap is suppressed, or moreover prevented.

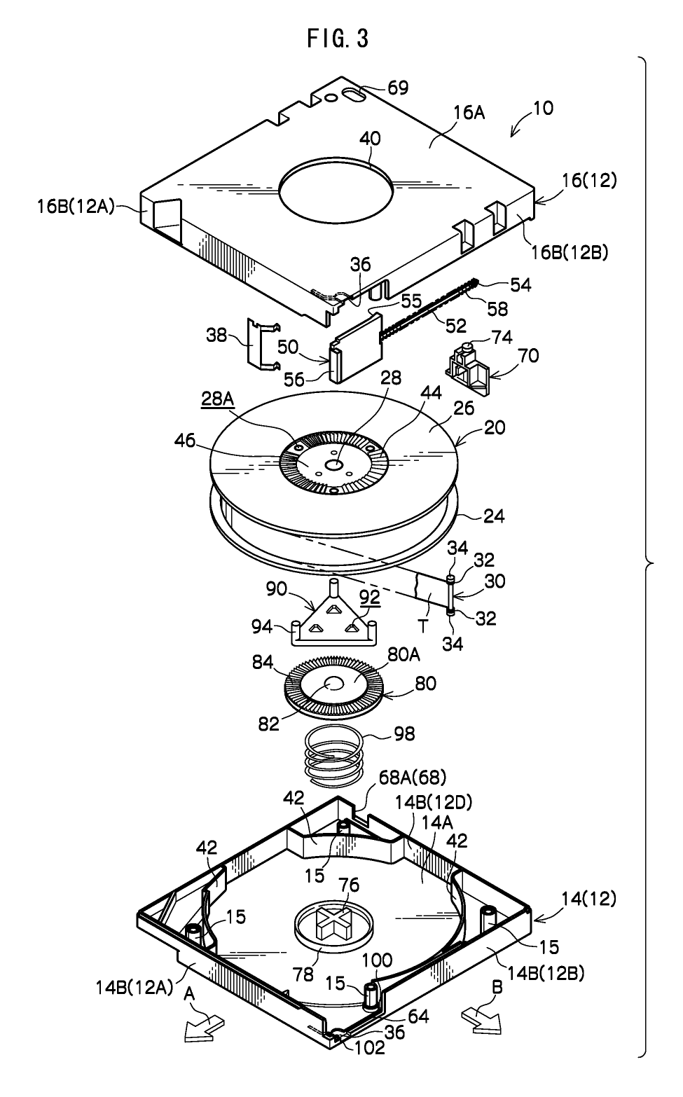

Further, as shown in FIGS. 2 and 3, a write-protector 70, for setting recording to the recording tape T as possible or impossible, is provided so as to be slidable in the left and right directions at the left rear portion of the casing 12. A hole 68 through which a manual switch 72 protrudes for manually operating this write-protector 70 is formed in the rear side wall 12D of the casing 12. The hole 68 is formed from a notch 68A formed in the peripheral wall 14B of the top casing 14 and a notch 68B formed in the peripheral wall 16B of the bottom casing 16, when the top casing 14 and the bottom casing 16 are joined.

In addition, a long hole 69, extend in the left-right direction, is formed piercing through the lower casing 16 so that a protrusion 74 of the write-protector 70 is exposed therethrough, and determination is made automatically as to whether or not the recording tape T is writable or non-writable by the drive device side detecting the position of the write-protector 70 when the recording tape cartridge 10 is loaded into the drive device. The protrusion 74 does not protrude out from the bottom face of the lower casing 16. A memory board M, stored with various information such as the recording capacity, recording format etc., is also provided at a specific angle at a right-rear portion of the casing 12, as shown in FIG. 2.

Further, as shown in FIGS. 2 and 3, multiple engaging gears 48 (e.g., three at intervals of 120°) are provided extending up from the peripheral edges on the top surface of the bottom wall 28 of the reel hub 22, separated at preset intervals (uniform intervals). Multiple through-holes 28A (in this case three, at intervals of 120°) are provided at preset positions on the reel gear 44 between the engaging gears 48. A circular disc brake component 80 formed from a resin material is provided so as to be inserted inside the reel hub 22.

Brake gears 84 that can engage with the engaging gears 48 are formed in a ring shape on the peripheral edge of a bottom surface 80A of the brake component 80. Rotation-restricting ribs 76 formed in substantially a cross shape in plan view are provided on the upper surface of the brake component 80 so as to protrude downward from the inner surface of the top panel 14A of the top casing 14. The rotation-restricting ribs 76 are inserted into the interior of engaging protrusions 86 that also have a substantially cross shape in plan view, and the engaging protrusions 86 are provided with a height extending slightly higher than the height of the rotation-restricting ribs 76. Due to this, the brake component 80 cannot be rotated relative to the casing 12 (i.e., the top casing 14) but it is movable in the up and down directions inside the reel hub 22.

A compression coil spring 98 is also arranged between the top casing 14 and the brake component 80. That is, the compression coil spring 98 is disposed in a state such that one end of the compression coil spring 98 comes into contact with the upper casing 14 at the inside of a ring shaped protrusion 78 that protrudes out from the top casing 14 at the outside of the rotation restricting ribs 76 (i.e., between the rotation-restricting ribs 76 and the circular protrusion 78) and the other end of the compression coil spring 98 is in contact with the inside of an annular groove 88 provided on the upper surface of the brake component 80. The brake component 80 is constantly biased downwards due to the biasing force of the compression coil spring 98.

Accordingly, the brake gears 84 are always engaged with the engaging gears 48 when the recording tape cartridge 10 is not in use (i.e., when the tape is not loaded into a drive device), in a state of rotational lock where the gears are blocked from rotating relative to the casing 12 of the reel 20. It should be noted that at this time, the reel 20 is pressed towards the bottom casing 16 side by this biasing force and this exposes the reel gear 44 from the gear opening 40.

A releasing component 90, formed from a resin material in substantially an equilateral triangle shape in plan view, fits inside the reel hub 22 below the brake component 80 (between the bottom wall 28 and the brake component 80). Plural through-holes 92 are formed of a specific shape at appropriate locations on the releasing component 90 (three hexagonal shaped holes in the illustrated example), in order to achieve a reduction in weight of the releasing component 90. Legs 94 are formed to portions at the apexes of the bottom face of the releasing component 90, with each of the top portions of the legs 94 fitting through the through-holes 28A and projecting out from the bottom face of the bottom wall 28 with a specific height above the reel gear 44.

A support protrusion 96 is formed as a flat surface at the center of a top face 90A of the releasing component 90, so as to abut a substantially semi-spherical shaped release protrusion 82 projecting out from the center of a bottom face 80A of the brake component 80 (see FIG. 2 and FIG. 3). The area of surface contact between the brake component 80 and the releasing component 90 is thereby reduced, a configuration that reduces the sliding resistance when in use (when the reel 20 is rotating). Polyacetal (POM) is used, for example, as the material for the brake component 80, and polybutylene terephthalate (PBT) is used, for example, as the material for the releasing component 90.

Explanation will now be given of operation of the recording tape cartridge 10 configured as described above. When not in use (when being stored or when being transported) the opening 18 of the recording tape cartridge 10 is blocked off by the door 50. The brake component 80 is positioned in the rotation locked position due to biasing force from the compression coil spring 98, meshing the brake gears 84 with the engaging gears 48. The reel 20 is thereby prevented from rotation with respect to the casing 12.

In such a state the outside face of the rear end portion of the door 50 is in press contact with the inside face of the right side wall 12B due to the biasing projections 100. Namely, there is the tapered face 55 at the inside face of the rear end portion of the door 50, such that the plate thickness thereat is thicker than at other positions of the door 50, with the maximum plate thickness the same as, or greater than, the smallest separation distance (gap) between the biasing projections 100 and the inside face of the right side wall 12B.

Consequently, when the opening 18 is blocked off by the door 50, the rear end portion of the door 50 is pressed at the tapered face 55 toward the outside of the casing by the biasing projections 100, and pressed toward the right side wall 12B side. Any gap which might have arisen between the edge portion at the right side wall 12B where the opening 18 is formed (the edge portion in the direction of sliding when the door 50 is being opened) and the door 50 is substantially blocked by the door 50 itself, and intrusion of dust etc. through such a gap is suppressed, or moreover prevented.

In such a state the inside face of the front end portion of the door 50 is pressed against (is in press contact with) the right end face 12C of the front wall 12A due to the ancillary biasing projections 102 that project out in the vicinity of the edge portion at the front wall 12A side of the right side wall 12B. Consequently any gap which might have arisen between the inside face of the front end portion of the door 50 and the right end face 12C of the front wall 12A is substantially blocked by the door 50, and intrusion of dust etc. through such a gap is suppressed, or moreover prevented.

When the recording tape T is in use, the recording tape cartridge 10 is loaded into the drive device along the direction of arrow A, with the front wall 12A as the leading edge. When this is carried out, the opening and closing member provided to the drive device side first engages with the protruding portion 56 of the door 50. Then, when in this state the recording tape cartridge 10 moves further in the direction of arrow A, the opening and closing member moves the protruding portion 56 relatively toward the rear against biasing force of the coil spring 58. When this occurs the door 50, from which the protruding portion 56 is projecting, slides toward the rear within the grooved portions 64 substantially along the right side wall 12B (at the inside of the right side wall 12B).

When the recording tape cartridge 10 is loaded to a specific depth into the drive device, the opening 18 is completely opened, the recording tape cartridge 10 descends a specific height, and positioning members (not shown in the drawings) of the drive device are inserted into positioning hole portions (not shown in the drawings) formed in the lower casing 16. The recording tape cartridge 10 is thereby accurately positioned at a specific position in the drive device, and any further sliding or movement further to the rear of the door 50 is restricted.

Further, the rotation shaft is relatively inserted from the gear opening 40 with the descending movement of the recording tape cartridge 10 and makes the drive gear engage with the reel gear 44. As this occurs, the legs 94 protruding above the reel gear 44 are pressed upwards against the biasing force of the compression coil spring 98 along with the engaging action of the drive gear with the reel gear 44. The brake component 80 is pressed upwards via the releasing component 90, and engagement of the brake gears 84 and the engaging gears 48 is released.

When the drive gear is in a fully meshed state with the reel gear 44, the reel plate 46 is attracted and retained by magnetic force of the ring shaped magnet provide inside the drive gear, and the reel 20 becomes in a lock-released state, relatively rotatable with respect to the casing 12, within the casing 12, while meshing of the reel gear 44 with the drive gear is maintained.

A pull-out component (not shown) provided on the drive device side enters into the casing 12 from the opening 18, grasps the leader pin 30 positioned and retained by the pin-retaining portions 36, and pulls the leader pin 30 out. It should be noted that at this time, the recording tape cartridge 10 is precisely positioned inside the drive device so the pull-out component can latch its hooks to the annular grooves 32 of the leader pin 30 with certainty. Further, the state of rotational lock of the reel 20 is released so the reel 20 can rotate with the pulling out action of the leader pin 30.

In this manner, the leader pin 30 removed from the opening 18 is accommodated on a take-up reel (not shown). The take-up reel and the reel 20 are then driven and rotated in synchronization, whereby the recording tape T is taken up on the take-up reel while being gradually pulled out from the casing 12. Recording and reproduction of data is performed with a recording/reproduction head (not shown) arranged along a preset tape route.

When recording or reproduction of information is completed and the recording tape cartridge 10 is to be ejected from the recording tape cartridge 10, first the recording tape T is rewound onto the reel 20 by rotating the rotation shaft in reverse. When the recording tape T has been rewound to the end onto the reel 20 and the leader pin 30 has been retained in the pin-retaining portions 36, the recording tape cartridge 10 ascends by the specific height and the rotation shaft is removed from the gear opening 40 as the position members for positioning are removed from the positioning hole portions, with the meshing of the drive gear with respect to the reel gear 44 being released.

When this occurs, the brake component 80 and the release member 90 are pressed downward by biasing force of the compression coil spring 98, the leg portions 94 inserted through the through-holes 28A project out above the reel gear 44 by a specific height from the bottom surface of the bottom wall 28, and the brake gears 84 is meshed with the engaging gears 48. The reel 20 is thereby placed once again in a rotation locked state, in which relative rotation within the casing 12 is prevented, and the recording tape cartridge 10 is then moved in the opposite direction to the direction of arrow A by a non-illustrated eject mechanism.

When this occurs, the door 50 is slid in the direction to block the opening 18 by biasing force of the coil spring 58, to completely block off the opening 18 (return to the initial state). In this state the rear end portion of the door 50 is pressed toward the right side wall 12B side by the biasing projections 100, hence the outside face at the rear end portion of the door 50 is in press contact (abuts) the inside face of the right side wall 12B. Any gap formed between the door 50 and the edge portion of the right side wall 12B is thereby substantially blocked off by the door 50, and consequently intrusion of dust etc. through such a gap can be suppressed, or moreover prevented.

When this occurs the front end portion of the door 50 is also pressed to the right end face 12C side of the front wall 12A by the ancillary biasing projections 102, and so the inside face of the front end portion of the door 50 is in press contact (abuts) the right end face 12C of the front wall 12A. Any gap formed between the inside face of the front end portion of the door 50 and the right end face 12C of the front wall 12A is thereby substantially blocked off by the door 50, and consequently intrusion of dust etc. through such an gap can be suppressed, or moreover prevented. The recording tape cartridge 10 is then ejected from within the drive device, with the reel 20 locked from relative rotation with respect to the casing 12 and the opening 18 blocked off.

Explanation has been given of the recording tape cartridge 10 according to the present exemplary embodiment, however the recording tape cartridge 10 according to the present exemplary embodiment is not one limited to the illustrated exemplary embodiment, and appropriate design changes and modifications may be made thereto within a scope not departing from the spirit of the present invention. For example, in the above exemplary embodiment the door 50 is configured to slide at the inside of the right side wall 12B to open and close the opening 18, however configuration may be similarly made with the door 50 sliding at the outside of the right side wall 12B to open and close the opening 18.

In addition, in the illustrated exemplary embodiment the biasing projections 100 are provided projecting out from the inside face of the top panel 14A of the upper casing 14 and the inside face of the bottom panel 16A of the lower casing 16, however configuration may be made with a biasing projection 100 projecting only out from the inside face of the top panel 14A of the upper casing 14, or only from the inside face of the bottom panel 16A of the lower casing 16. In a similar manner the ancillary biasing projection 102 may also be provided only on the upper casing 14 side or only on the lower casing 16 side. The tapered face 55 of the door 50 also is not necessarily formed across the entire height direction of the door 50, and configuration may be made, for example, in which the tapered face 55 is only formed in locations that are in press contact (abut) the biasing projections 100.

The recording tape T wound on the reel 20 is one which falls within the definition of an information recording and reproduction medium of a long tape shape, capable of recording information and reproducing the recorded information, and the recording tape cartridge 10 rotatably accommodating a single reel 20 is obviously applicable to any recording and reproducing format.

What is claimed is:

1. A recording tape cartridge comprising:
a casing that rotatably accommodates a single reel on which recording tape is wound;
a shielding component that slides substantially along a side wall of the casing to open or block off an opening that is formed in the side wall for pulling out the recording tape; and
a biasing projection provided projecting out from the casing and biasing the shielding component toward the side wall side when the shielding component has blocked off the opening.

2. The recording tape cartridge of claim 1, wherein the biasing projection projects out in the vicinity of an edge portion of the side wall where the opening is formed.

3. The recording tape cartridge of claim 1, wherein the maximum plate thickness of a portion of the shielding component interposed between the side wall and the biasing projection when the opening is blocked off is the same thickness as, or a greater thickness than, the separation between the side wall and the biasing projection.

4. The recording tape cartridge of claim 1, wherein a leader component is attached to an end portion of the recording tape for pulling out the recording tape.

5. The recording tape cartridge of claim 1, wherein the biasing projection is provided for biasing at positions in the vicinity of each of the two ends in the sliding direction of the shielding component for blocking the opening.
